(19) United States
(12) Patent Application Publication
(10) Pub. No.: US 2018/0197161 A1
(43) Pub. Date: Jul. 12, 2018

(54) SYSTEM AND METHOD FOR MULTI-LAYERED BILLING IN A CLOUD SERVICE BROKERAGE

(71) Applicant: INGRAM MICRO INC., Irvine, CA (US)

(72) Inventors: Maxim Kuzkin, Irvine, CA (US); Vladimir Zatsepin, Mytishchi (RU); Pavel Khodos, Anaheim, CA (US); Oleg Melnikov, Kirkland, WA (US)

(21) Appl. No.: 15/857,305

(22) Filed: Dec. 28, 2017

Related U.S. Application Data
(60) Provisional application No. 62/439,619, filed on Dec. 28, 2016.

(51) Int. Cl. G06Q 20/14; G06Q 20/10; G06Q 30/04; G06Q 30/02

(52) U.S. Cl. CPC G06Q 20/145; G06Q 30/0283; G06Q 30/04; G06Q 20/102

(57) ABSTRACT

A system for multi-layered billing in a cloud service brokerage is provided, including at least one service vendor configured to provide software services, a cloud service broker, at least one transaction mediator, at least one downstream subscriber, where the cloud service broker receives service vendor pricing rules, service vendor billing rules, downstream subscriber pricing rules, and downstream subscriber billing rules, the cloud service broker further configured to apply the service vendor pricing rules and the service vendor billing rules, and to calculate settlements and perform reconciliations. A method of multi-layered billing in a cloud service brokerage is also provided, the method includes configuring a software service, integrating software services to create integrated software services, establishing a communication provisioning channel, monitoring using at least one transaction mediator the integrated software services, creating a subscription to the integrated software services, receiving service vendor pricing rules, service vendor billing rules, downstream subscriber pricing rules, and downstream subscriber billing rules, applying the service vendor pricing rules and the service vendor billing and calculating and performing settlements and reconciliations.

### PRIORITY

This utility patent application claims priority to, and incorporates by reference herein, the disclosure of U.S. Provisional Patent Application No. 62/439,619, filed Dec. 28, 2016.

### TECHNICAL FIELD

This disclosure relates to a system and method of billing, and more particularly, to a system and method for multi-layered billing in a cloud service brokerage.

### BACKGROUND

Currently, many software vendors offer their software via online service platforms. Such software as a service (SaaS) platforms, allow SaaS subscribers/end users to obtain and use software services that are hosted by the SaaS provider. SaaS, also referred to as “on-demand software,” is usually priced on a pay-per-use basis, or using a subscription fee. For example, a SaaS subscriber can pay a monthly (or yearly) subscription fee to the SaaS vendor for access to the SaaS platform for a particular time period (e.g. for a month). Conversely, in a pay-per-use scheme, a SaaS subscriber pays the SaaS provider based on the subscriber's usage of the SaaS platform, within a given period. For example, a subscriber may be charged based on a rate per usage, the usage being metered based on one or more resources within the SaaS platform. In these “subscriber-vendor” schemes, billing between a subscriber and a SaaS vendor is a one-to-one relationship wherein the SaaS vendor's costs are passed directly to the subscriber, which the subscriber will then pay to ensure continued access to the SaaS platform.

In an alternate system of software services distribution, a cloud services broker is used. A cloud services broker is an organization that acts as an intermediary between subscribers/end users and SaaS vendors. A cloud services broker may integrate different software services (available from various SaaS vendors) to present a unified set of services (i.e. a cloud services package) to a subscriber. In some situations, the cloud services broker also hosts the software services and operates in the stead of a traditional SaaS vendor. Additionally, the cloud services broker allows for the provisioning and selling of subscriptions to a variety of SaaS vendors at different levels, resulting in a hierarchical system of downstream resellers. These resellers can subsequently re-sell services to sub-resellers and end-users. In some situations, these re-sellers may price the SaaS offerings at different pricing schemes compared to the SaaS vendors and/or the cloud brokers.

Billing in a cloud services broker system is managed through the cloud services broker because the cloud services broker is the only entity capable of managing the many relationships in such a software distribution system. The complexities of billing in a cloud broker system arise because of the intermingling of the types of SaaS vendors, the influence of resellers, and the various billing schemes offered by each of these entities. For example, a cloud services package may include a plurality of software services from a plurality of SaaS vendors. The each of these pluralities of software services in the cloud services package may include various billing schemes (e.g. a combination of usage based and subscription based schemes, and each with varying incentives and billing attributes). Furthermore, downstream resellers may offer their own unique pricing schemes for the cloud services package.

When subscriber end users obtain software services from the cloud services broker, or a downstream reseller, billing for these subscriber end users is not a one-to-one relationship like in the traditional “subscriber-vendor” scheme. Instead, subscriber end users in the cloud services broker scheme may be billed based on different pricing within the layers of the cloud services brokerage distribution channel. Therefore, implementing such a billing scheme must account for the variations in billing rules and billing schemes from the entities throughout the hierarchy (i.e. SaaS vendors, resellers, sub-resellers, etc.). Furthermore, there may be a disparity between billing rules from upstream entities (e.g. SaaS vendors) and downstream entities (e.g. resellers), whereby billing imposed on subscriber end users based on one particular entity billing scheme is inappropriate. For example, fixed markups and discounts may be applied by upstream entities (e.g. SaaS vendors), which markups and discounts may not be appropriate for downstream entities (e.g. end users of resellers). Similarly if the same billing rules are applied on each level of the software distribution system, it would result in non-flexible contracts and rules of software services distribution. Additionally, there is an inability to customize pricing (and the corresponding billing rules) based on the specific types of entities in the distribution channel. For example, a direct subscriber end user may be charged differently than an indirect subscriber end user. This results in lost revenues across different elements of the software distribution system. Lastly, there is also the inability to perform wholesale purchases of services to be distributed following different billing rules, which also result in lost opportunity of larger service distributors.

Therefore, there is a need for an improved system and method for multi-layered billing in a cloud service brokerage.

### SUMMARY

In at least one embodiment of the present disclosure, a system for multi-layered billing in a cloud service brokerage is provided. The system includes service vendors, a cloud broker, resellers at different hierarchical levels such as first resellers, second resellers, and third resellers. The system further includes end customers where the end customers may receive services directly from the service vendors, or indirectly via resellers

In at least one embodiment of the present disclosure, the system for multi-layered billing in a cloud service brokerage includes a marketplace, a service provider database, a partner database, a marketplace broker, a federated connector, a transaction mediator, a usage database, a provisioning database, a connector, a scheduler, and network.

In at least one embodiment of the present disclosure, the marketplace broker is configured is configured to manage the contracts established between the various entities in the system.

In at least one embodiment of the present disclosure, the marketplace broker is configured to store a catalog of available services, configured to monitor the billing usage of the connector, and includes the federated connector.

In at least one embodiment of the present disclosure, the marketplace broker is configured to sell services via the marketplace to partners.

In at least one embodiment of the present disclosure, the marketplace further includes a transaction mediator configured to store the billing information about all transactions going through the system. The marketplace is further configured to store reconciliation-specific details about all transactions going through the system

In at least one embodiment of the present disclosure, the cloud broker may be operated by a partner, the partner operating to offer the service of the service vendor, to a subscriber.

In at least one embodiment of the present disclosure, the cloud broker is also configured to maintain a hierarchy of resellers and sub-resellers.

In at least one embodiment of the present disclosure, the cloud broker and the marketplace broker may operate as a singular entity.

In at least one embodiment of the present disclosure, a method for multi-layered billing in a cloud service brokerage is provided. The method includes determining transactions, as applied over billing periods, initiating a transaction, whereby the subscriber's billing cycle is updated or initiated based on the transaction attributes, calculating billing period costs, determining contracts between a service vendor and a cloud broker, and calculating the broker sales for each period.

In at least one embodiment of the present disclosure, the method includes maintaining records of the contracts and subscriptions for each service vendor, and calculating the each of the individual costs of the services during particular billing periods.

In at least one embodiment of the present disclosure, the method includes calculating costs at the each of the service vendor, calculating service costs at the cloud broker, calculating costs at the resellers, and generating a consolidated invoice for end customer(s).

In at least one embodiment of the present disclosure, costs are calculated for the each of the service vendor, the cloud broker, the resellers, and a consolidated invoice is generated for end customer(s)

In at least one embodiment of the present disclosure, the method includes reporting attributes of a provisioning operation to the transaction mediator, storing the data in the service usage database, requesting the service usage report for reconciliation with the service vendor, receiving billing rules of service vendor, calculating the total usage of the service, sending the report to the federated connector, transmitting the report to the marketplace broker, applying the pricing model of the service vendor to create a usage report for reconciliation with the service vendor, requesting the service usage report for partner invoicing, receiving billing rules from the partner's subscription, calculating the total usage of the service, sending the report to the federated connector, transmitting the report to the marketplace broker, applying the pricing model from the partner, and invoicing the partner.

### DESCRIPTION OF DRAWINGS

FIG. 1 displays a schematic drawing of a system for multi-layered billing in a cloud service brokerage.

FIG. 1A displays a schematic drawing of a system for multi-layered billing in a cloud service brokerage.

FIG. 1B displays a schematic drawing of a system for multi-layered billing in a cloud service brokerage.

FIG. 2 displays a schematic drawing of a system for multi-layered billing in a cloud service brokerage.

FIG. 2A displays a flowchart and components of a method for multi-layered billing in a cloud service brokerage.

FIG. 2B displays a flowchart and components of a method for multi-layered billing in a cloud service brokerage.

FIG. 2C displays a flowchart and components of a method for multi-layered billing in a cloud service brokerage.

FIG. 3 displays a flowchart and components of a method for multi-layered billing in a cloud service brokerage.

FIG. 4 displays a flowchart and components of a method for multi-layered billing in a cloud service brokerage.

FIG. 5 displays a flowchart and components of a method for multi-layered billing in a cloud service brokerage.

FIG. 6 displays a method of a system for multi-layered billing in a cloud service brokerage.

### DETAILED DESCRIPTION

Reference will now be made in detail to the preferred embodiments of the present disclosure, examples of which are illustrated in the accompanying drawings. Additional features and advantages of the disclosure will be set forth in the description that follows, and will be apparent from the description, or may be learned by practice of the disclosure. It is to be understood that both the foregoing general description and the following detailed description are exemplary and explanatory and are intended to provide further explanation of the disclosure as claimed.

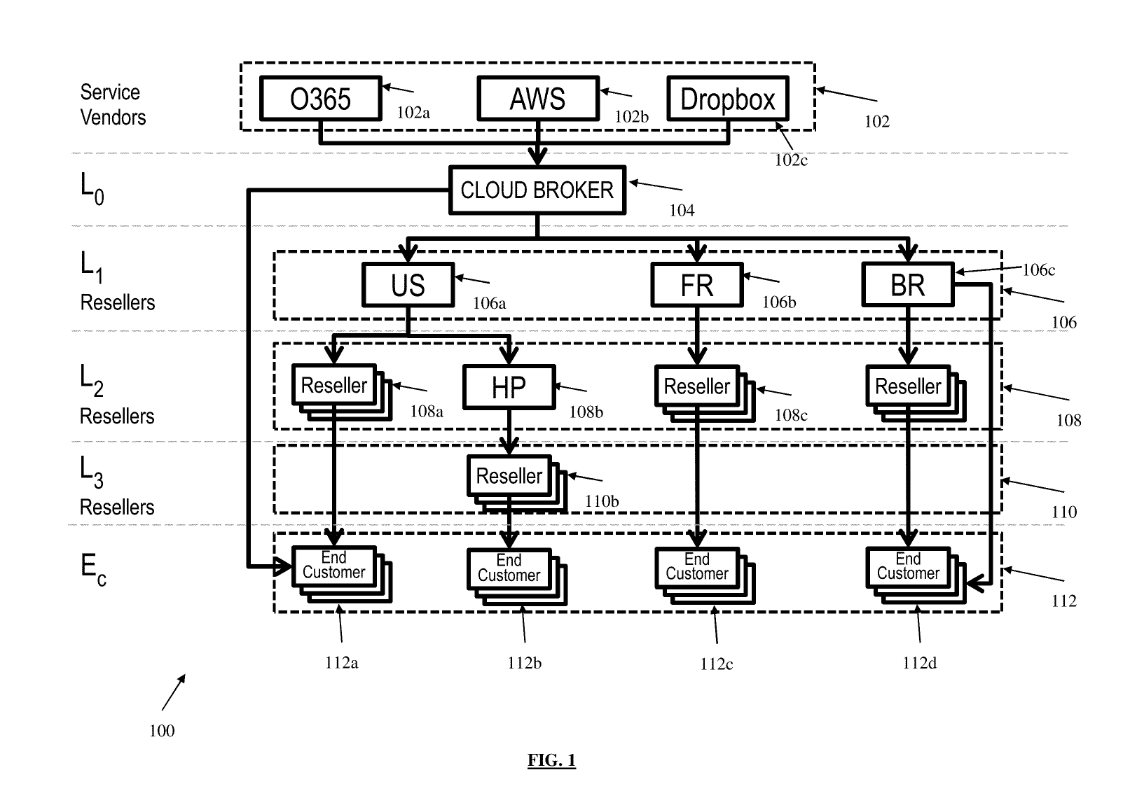

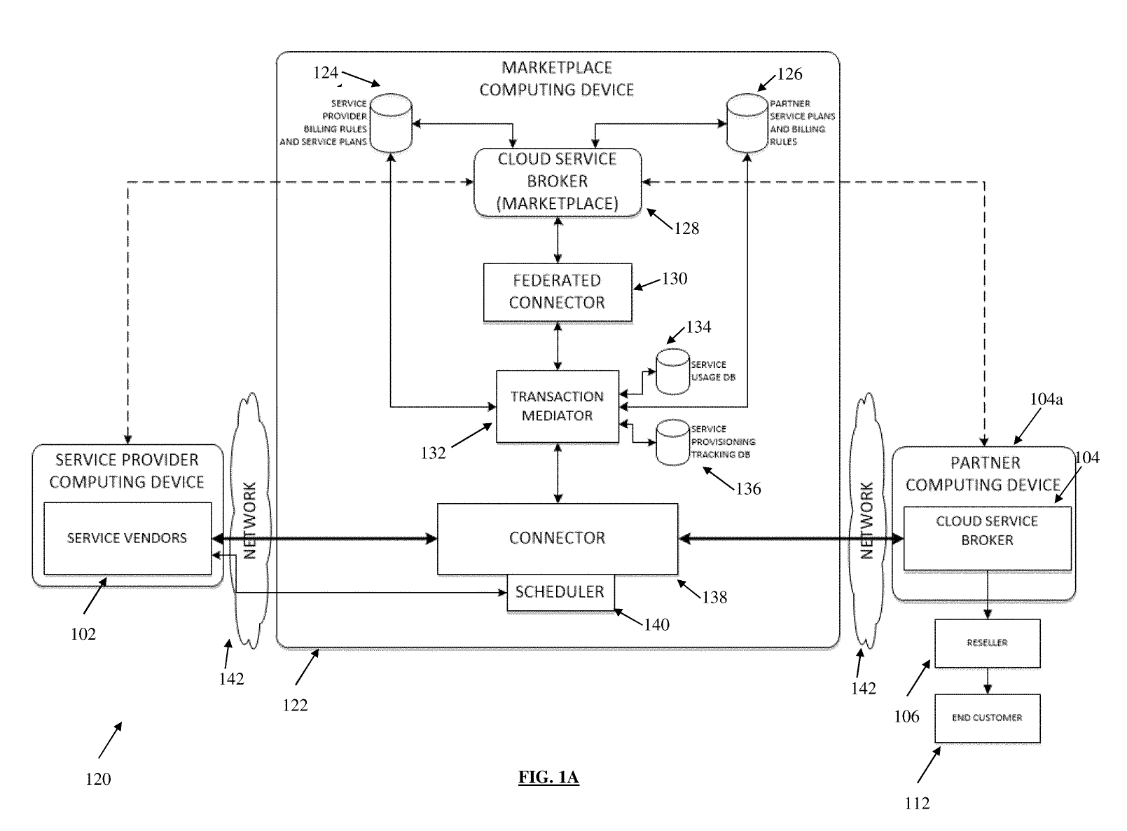

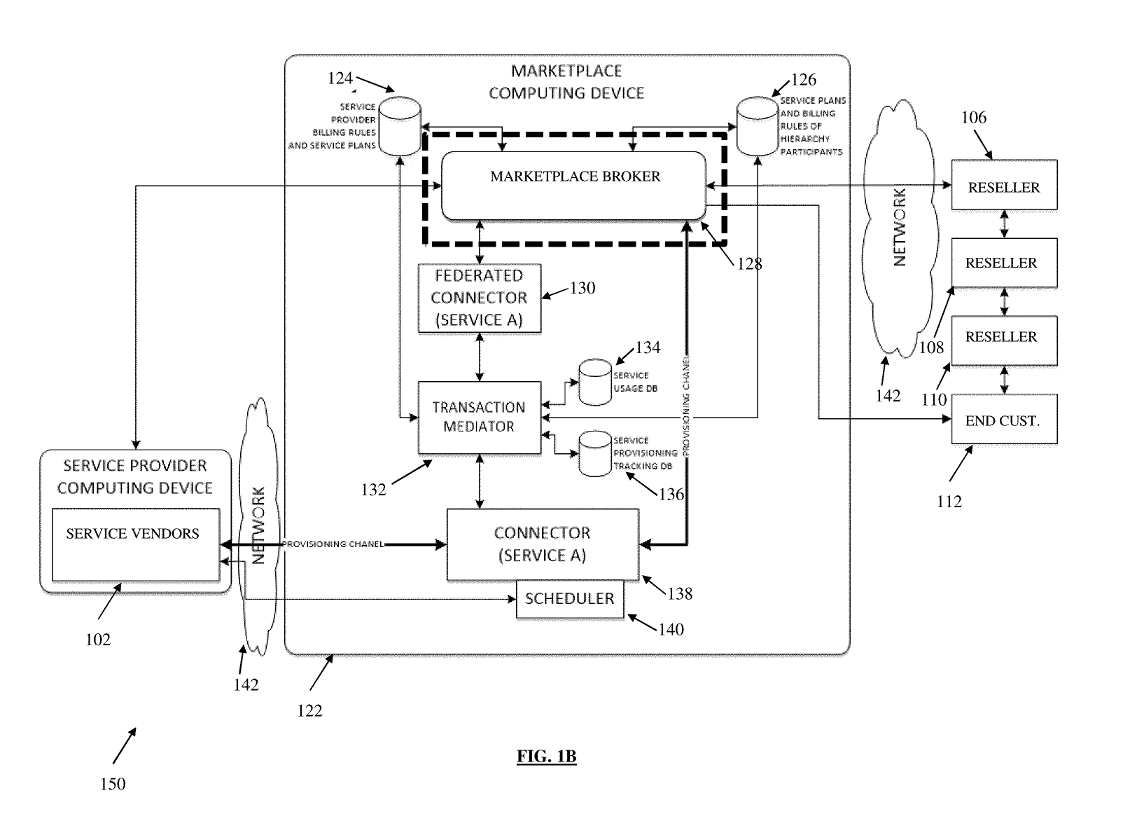

Referring now to FIG. 1, it is shown a system for multi-layered billing in a cloud service brokerage, generally indicated at 100. The system 100 includes service vendor 102, a cloud broker 104, first resellers 106, second resellers 108, third resellers 110, and end customers 112.

In at least one embodiment of the present disclosure, the service vendor 102 are entities that provide service subscriptions to its clients (e.g. business enterprises or customers of different size). For clarity, service vendor 102 may also be referred to as “service providers,” and it shall be understood that both terms may be used interchangeably. Additionally, the service vendor 102 can provide subscriptions to applications and services located on the independent software vendors' hosting servers (not shown). The service vendor 102 can further host services that are subscribed to by customers. Service vendors 120 may be software development companies that develop, support and run services (usually on their own cloud infrastructures). The service vendor 102 also sells and provides subscriptions to their services. It will be appreciated that the service vendor 102 provides an application programming interface (API) for each of its services. The API may include a set of classes, procedures, functions, structures and constants provided by the service vendor 102 for use in external applications. The service vendor 102 may include a plurality of service vendors (e.g. service vendor 102a, 102b, and 102c), such as, for example, Dropbox®, Amazon® Web Services, and Office 365®. The each of the plurality of service vendor 102 offer various software services, such as, email, web hosting, file sharing and storage, networks, telephony, messaging, video conference, general communication, enterprise resource planning (ERP), customer relationship management (CRM), supply chain management, to name a few, non-limiting examples. It will be appreciated that the service vendor 102 may offer their services to resellers or to end customers directly.

In at least one embodiment of the present disclosure, the service vendor 102 is configured to monitor usage of their services by resellers and end customers. For example, service vendor 102a (Office 365®) may be configured to monitor the compute resource usage caused by a subscriber's use of the service vendor 102a's service. It will be appreciated that the compute resources can include at least one metered metric selected from a group consisting of one or more compute resources used on a per time basis, one or more read and write I/O operations, and network bandwidth usage, to name a few, non-limiting examples. It will be further appreciated that the metering usage can be conducted at one or more of an application programming interface (API). It will also be appreciated that the metrics obtained from such monitoring may be stored in the service vendor 102's environment, or can be transmitted to other entities in the system 100, such as, for example, via the Internet.

It will be appreciated that the service vendor 102 may be configured to apply their own billing rules. For example, the service vendor 102b (e.g. Amazon® Web Services), may apply a flat rate, monthly pricing structure, while service vendor 102c (e.g. Dropbox®) may apply a rate commensurate with usage of compute resources. It will be further appreciated that the service vendor 102 may transmit billing rules to other entities in the system 100.

In at least one embodiment of the present disclosure, the system 100 further includes a cloud broker 104. A cloud broker 104 is an entity which integrates different software services (e.g. from service vendor 102) via an API and provides functionality of provisioning, and selling subscriptions to the services of the service vendor 102, to a variety of other entities (e.g. resellers and end customers). It will be appreciated that the cloud broker 104 provides user interfaces for different types of service vendor 102. For example, a service vendor that provides communications service (e.g. email), will have a different interface than a hosting or storage service vendor (e.g. Dropbox). It will be further appreciated that provision of different interfaces supports a hierarchical system of resellers, as further disclosed herein.

In at least one embodiment of the present disclosure, the system 100 further includes resellers at different hierarchical levels. For example, first resellers 106 may be geographically based resellers (e.g. first reseller 106a serves the U.S., first reseller 106b serves France, and first reseller 106c serves Brazil). The system 100 may further include downstream resellers, such as second resellers 108, and third resellers 110. The resellers may be organized based on any factor, such as geographic distribution, industry verticals, consumer verticals, or technology verticals, to name a few non-limiting examples. Although only a select number of resellers and downstream resellers are shown, it will be appreciated that the system 100 may include any number of resellers, and downstream resellers, connected by software and hardware systems of a type well known in the art (e.g. the Internet), which collectively are operable to perform the functions delegated to the resellers according to the present disclosure.

In at least one embodiment of the present disclosure, the system 100 further includes end customers 112. The end customers 112 may include individuals or enterprise organizations that are subscribing to services offered by the service vendor 102 (or those that may at least originate from service vendor 102). It will be appreciated that the end customers 102 may receive services directly from the service vendor 102, or indirectly via resellers. For example, referring to FIG. 1, end customer(s) 112a may receive services from second reseller 108a, wherein second reseller 108a is a downstream reseller for first reseller 106a. Similarly, end customer(s) 112b may receive services from third reseller 110b, wherein third reseller 110b is a downstream reseller of second reseller 108b, and further wherein second reseller 108b is a downstream reseller of first reseller 106a. It will be appreciated that each of the resellers is configured to use their own billing and pricing schemes, such that each of the end customers 112 may receive different pricing and billing terms even if they subscribe to the same services from the service vendor 102.

Referring now to FIG. 1A, it is shown a system for multi-layered billing in a cloud service brokerage, generally indicated at 120. The system 120 includes a marketplace 122, a service provider database 124, a partner database 126, a marketplace broker 128, a federated connector 130, a transaction mediator 132, a usage database 134, a provisioning database 136, a connector 138, a scheduler 140, and network 142.

In at least one embodiment of the present disclosure, the service provider database 124, the partner database 126, the usage database 134, and provisioning database 136 store information generated by the system 120 and/or retrieved from one or more information sources. In at least one embodiment of the present disclosure, the service provider database 124, and the partner database 126, can be “associated with” the marketplace broker 128, and the usage database 134, and provisioning database 136 can be “associated with” transaction mediator 132, as shown in the embodiment in FIG. 1A. The each of the service provider database 124, the partner database 126, the usage database 134, and provisioning database 136 can also be “associated with” a server or computing device remote from the marketplace 122, provided that the remote server or computing device is capable of bi-directional data transfer with marketplace 122, such as, for example, in Amazon AWS, Rackspace, or other virtual infrastructure, or any business network. In at least one embodiment of the present disclosure, the marketplace 122 upon which the each of the service provider database 124, the partner database 126, the usage database 134, and provisioning database 136 reside, is electronically connected to marketplace 122 (for example, via network 142), and the components therein such that they are capable of continuous bi-directional data transfer with each other.

For purposes of clarity, the each of the service provider database 124, the partner database 126, the usage database 134, and provisioning database 136 are shown in FIG. 1A, and referred to as single databases. It will be appreciated by those of ordinary skill in the art that the each of the service provider database 124, the partner database 126, the usage database 134, and provisioning database 136 may comprise a plurality of databases connected by software systems of a type well known in the art, which collectively are operable to perform the functions delegated to the each of the service provider database 124, the partner database 126, the usage database 134, and provisioning database 136 according to the present disclosure. The each of the service provider database 124, the partner database 126, the usage database 134, and provisioning database 136 may also be part of distributed data architecture, such as, for example, a Hadoop architecture, for big data services. The each of the service provider database 124, the partner database 126, the usage database 134, and provisioning database 136 may comprise relational database architecture, noSQL, OLAP, or other database architecture of a type known in the database art. The each of the service provider database 124, the partner database 126, the usage database 134, and provisioning database 136 may comprise one of many well-known database management systems, such as, for example, MICROSOFT's SQL Server, MICROSOFT's ACCESS, MongoDB, Redis. Hadoop, or IBM's DB2 database management systems, or the database management systems available from ORACLE or SYBASE. Each of the service provider database 124, the partner database 126, the usage database 134, and provisioning database 136 retrievably stores information that is communicated to it, as further disclosed herein.

In at least one embodiment of the present disclosure, the marketplace broker 128 is configured is configured to manage the contracts established between the various entities in the system 100 (e.g. service vendor 102, cloud broker 104, first resellers 106, end customers 112, etc.). For example, every subscription to a service offered by any of the plurality of service vendor 102 is governed by a contract, wherein the contract memorializes the terms of the service such as pricing, licensing costs, and service level agreements, to name a few non-limiting examples. Similarly, resellers (e.g. first resellers 106) may have additional (or different) contract terms wherein an end customer 112's receipt of service is governed by the terms of the reseller contract, as opposed to the terms of the service vendor's contract. In such an exemplary embodiment, the possibility to provision, sell and modify a particular service is managed by the applicable contract terms of the service vendor 102.

In at least one embodiment of the present disclosure, the marketplace broker 128 is configured to store a catalog of available services (i.e. the services offered by service vendors or resellers). A service offered by service vendor 102 is considered ‘available’ when the service vendor 102 has a contract with the marketplace 122. In the process of assigning a contract, the service providers 102 may provide service plans, billing rules for each service (e.g. an SKU, as further disclosed herein) and a connector (e.g. connector 138) to the marketplace 122. The service vendor 102's plans and billing rules are stored in the service provider database 124.

In at least one embodiment of the present disclosure, the marketplace broker 128 is further configured to monitor the billing usage of the connector 138. For example, partner 104a may be an entity that desires to offer service based on service vendor 102. When the partner 104a creates a new service offering based on the service vendor 102, the partner 104a uses the connector 138 to operably connect to the marketplace 122, such that the services of the service vendors 112 can be contracted for. This may be considered as ‘provisioning.’ For example, referring to FIG. 1A, cloud broker 104 may be operated by the partner 104a, wherein the partner 104a desires to offer the services of service vendor 102. In such an exemplary embodiment, the partner 104a is made ‘available’ via the marketplace 122, via the use of the connector 138 (i.e. the service vendor 102 are made available to the partner 104a via the use of the connector 138). Continuing with this example, the partner 104a may now provide the services to resellers 106 or even end customers 112, after being provisioned.

In at least one embodiment of the present disclosure, the marketplace 122 further includes the federated connector 130, the federated connector 130 configured to receive usage reports based on partner subscription from the transaction mediator 132 (as further disclosed herein). For example, a contract between a marketplace broker and a partner may require that the invoices be sent on the first day of the month, wherein the federated connector 130 sends the requests to the transaction mediator 132 on the first day of the month, to receive the necessary data.

In at least one embodiment of the present disclosure, the marketplace 122 further includes the connector 138. The connector 138 is configured specifically for every service (for example, a service provided by any of the service vendor 102). For each of the plurality of service vendor 102 (for example, as shown in FIG. 1), the connector 138 is configured to distinguish one subscription from another as further disclosed herein. The connector 138 is configured to identify the source of the service (i.e. the identity of the service vendor 102) and the destination of the service (e.g. the identity of end customers 112). It will be appreciated that the connector 138 may also receive information about the services during the provisioning of the services. In at least one embodiment of the present disclosure, the connector 138 is configured to define a partner 104a and its subscriptions because the connector 138 is deployed on a per partner subscription basis. It will be appreciated that any tenant (e.g. end customers 112) and end-user IDs are generated by cloud broker 104, and a subscription ID is generated by service vendor 102, when the each of the plurality of service vendor 102 confirms to the connector 138 that provisioning has been successfully completed. It will be further appreciated that although a single connector 138 is shown, the system 120 may include as many connector 138s as needed to support the each of the plurality of service vendor 102. For example, if marketplace broker 128 purchased N subscriptions for N different services, the marketplace 122 may provide N connector 138 instances for the each of the N different services.

In at least one embodiment of the present disclosure, the marketplace broker 128 is configured to sell services via the marketplace 122 to partners (e.g. partner 104a) in accordance with service plans for that particular partner. It will be appreciated that for each sale of a partner's services, the marketplace broker 128 sends a request to a connector hub (not shown, but as disclosed in U.S. application Ser. No. 15/005,151, for PROVISIONING APPLICATIONS USING A CONNECTORS HUB SERVICE, which application is incorporated in its entirety by reference herein) to deploy a connector instance (e.g. connector 138) for the partner (e.g. partner 104a) to operably connect with the marketplace 122, and to tune the provisional channel. At the same time, the marketplace broker 128 provides billing service to the partner via the federated connector 130 and transaction mediator 132. It will be appreciated that the marketplace broker 128 operates in the same manner as the cloud broker 104 but that the cloud broker 104 provides the channel to sell software as a service, while marketplace broker 128 provides the mechanism to provision the service that will be eventually sold as a service.

In at least one embodiment of the present disclosure, the connector 138 is operably connected to the transaction mediator 132, for example, when provisioning of a service is accomplished. The connector 138 is further configured to report to the transaction mediator 132, wherein the report includes, a date of activation, provisioning, cancellation, change, service ID (as further disclosed herein), identification of a cloud service broker, the number of services, markers of actions such as activation, change and cancellation, to name a few non-limiting examples. It will be further appreciated that the connector 138 may report ID's of entities within a hierarchical billing system. For example, entities may include first resellers 106, second resellers 108, third resellers 110, and end customers 112. The connector 138 further operates to perform analysis of the activities by the transaction mediator 132.

In at least one embodiment of the present disclosure, the system 120 further includes a scheduler 140 that is operably connected to the connector 138. It will be appreciated that in an exemplary embodiment selling services include disk space, CPU-time (pay-as you go services). The scheduler 140 is configured to provide tracking of resource usage (e.g. disk space usage, CPU-time), by sending periodic requests to the applicable service vendor 102, to retrieve such information. The scheduler 140 is further configured to transmit resource usage information to the transaction mediator 132 as needed, or periodically.

In at least one embodiment of the present disclosure, the marketplace 122 further includes a transaction mediator 132. A transaction mediator 132 is configured to store the billing information about all transactions going through the system 120. For example, a transaction between end customer(s) 112 and service vendor 102a, may be of a type such as a purchase of software from the service vendor 102a, an upgrade of the software and/or services from the service vendor 102a, a downgrade of the software and/or services from the service vendor 102a, a cancellation of the services from the service vendor 102a, or the like. In at least one embodiment of the present disclosure, the transaction mediator 132 is further configured to track a service identifier, the service identifier being an alphanumeric identifier of a resource type related to the transaction. The transaction mediator 132 is further configured to track the unit of measure (UOM) such as for example, the number of units or licenses being used by the subscriber(s) of the service vendor 102. The transaction mediator 132 may also track the quantity and start and end dates of the service usages, as well as receive any metering or monitoring of compute resource usage, and billing rules from the service vendor 102, to name a few, non-limiting examples.

In at least one embodiment of the present disclosure, the marketplace 122 is further configured to store reconciliation-specific details about all transactions going through the system 120, via the transaction mediator 132. For example, each of the plurality of service vendor 102 may have a vendor identifier (ID) associated therewith. The transaction mediator 132 is further configured to collected other identifiers such as, for example, service vendor-side data (e.g. subscription ID); any other unique identifiers; a partner identifier or subscription ID for any resellers or end customers; partner-side data (e.g. end-customer's subscription ID) and order identifier.

It will be appreciated that for every transaction, the transaction mediator 132 must store minimal amount of data required to report (if applicable), the vendors' identity, the resellers' identify, the end customers' identity, the billing rules from the service vendor 102 and the resellers (e.g. first reseller 106, second reseller 108, third reseller 110), and usage and pricing for the each entity in the system 100.

In at least one embodiment of the present disclosure, the cloud broker 104 may be operated by partner 104a, the partner 104a operating to offer the service of the service vendor 102, to a subscriber. It will be appreciated that the cloud broker 104 is further configured to receive usage information of all tracked resource types by request, and aggregated by resource type and prorated according to terms set forth by the service vendor 102 (or the resellers). Continuing with the previous example, if service vendor 102a (Office 365®) is configured to bill based on compute resource usage caused by a subscriber, the vendor 102a may track this information and the transaction mediator 132 is configured to receive this information.

In at least one embodiment of the present disclosure, the cloud broker 104 is also configured to maintain a hierarchy of resellers and sub-resellers. For example, a cloud broker 104 may serve first resellers 106, second resellers 108, third resellers 110, and end customers 112 (as shown in FIG. 1). In such an exemplary embodiment, the cloud broker 104 is configured to capture and maintain consumption of cloud services by subscribing entities. It will be appreciated that the cloud broker 104 is configured to enable a partner to capture and bill usage of subscriber (e.g. end customers 112), while marketplace broker 128 may operate to bill the partner for usage of the connector 138.

It will be appreciated that the transaction mediator 132 is further configured with a software agent to record transactions, indicative of individual billable provisioning operations of a cloud service, passing between an end customer(s) 112 and service vendor 102. In at least one embodiment of the present disclosure, the information pertinent to the transactions is then processed and passed on to a central system (e.g. marketplace 122) where it could be extracted for billing purposes. It will be further appreciated that by monitoring the provisioning flow, the cloud broker 104 can provide real time billing information without the need to rely on the same billing rules imposed by service vendor 102's data.

In at least one embodiment of the present disclosure, the cloud broker 104 and the marketplace broker 128 may operate as a singular entity, as shown at system 150, in FIG. 1B. It will be appreciated that the marketplace broker 128 can perform the same function as the cloud broker 104, as further disclosed herein.

In at least one embodiment of the present disclosure, the system 150 includes a first reseller 106, second reseller 108, third reseller 110, and end customer 112. It will be appreciated that the second reseller 108 may include a sub-reseller, wherein the sub-reseller operates to further resell the services from first reseller 106, as disclosed above. It will be further appreciated that the third reseller 110 may include a tenant subscribing to services from the marketplace broker 128, wherein the tenant operates to use the services. It will be further appreciated that the end customer 112 may be an end user of the tenant (e.g. an employee end user of a company tenant that has subscribed to the services), or an end user of a reseller type entity (e.g. a direct consumer of integrated software services provided by reseller 110).

In at least one embodiment of the present disclosure, the marketplace broker 128 is operably configured to provision the first reseller 106, second reseller 108, third reseller 110, and end customer 112, as needed in order for each party to perform its own billing and pricing rules, as further disclosed herein.

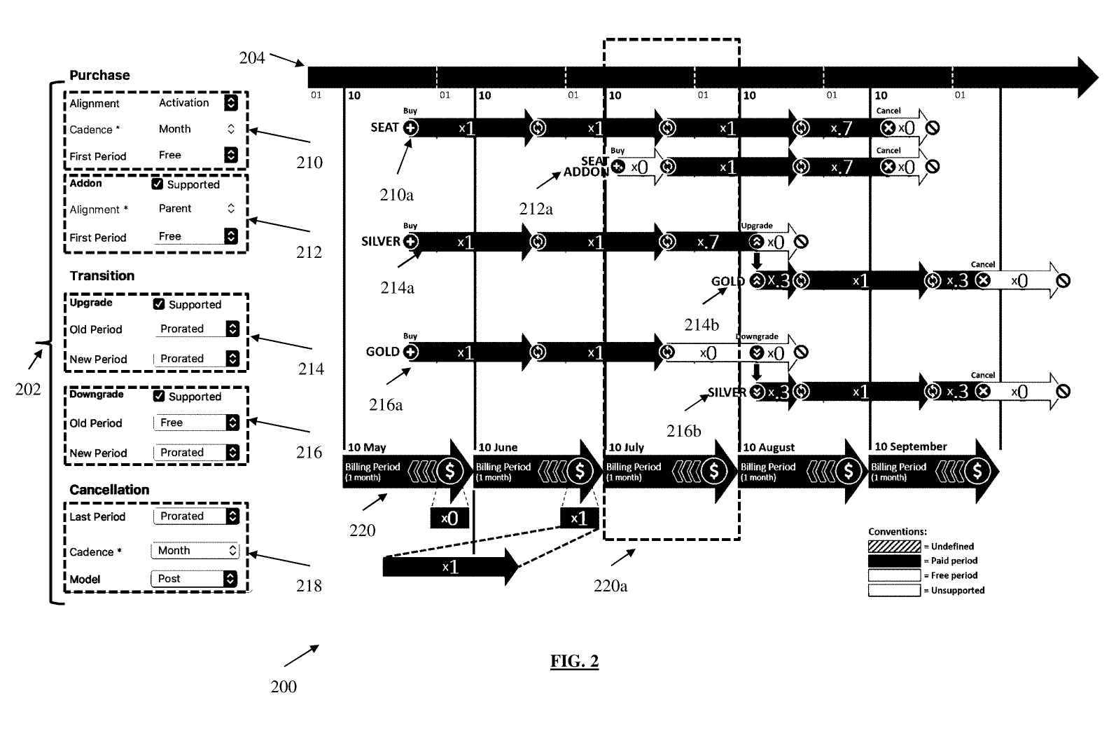

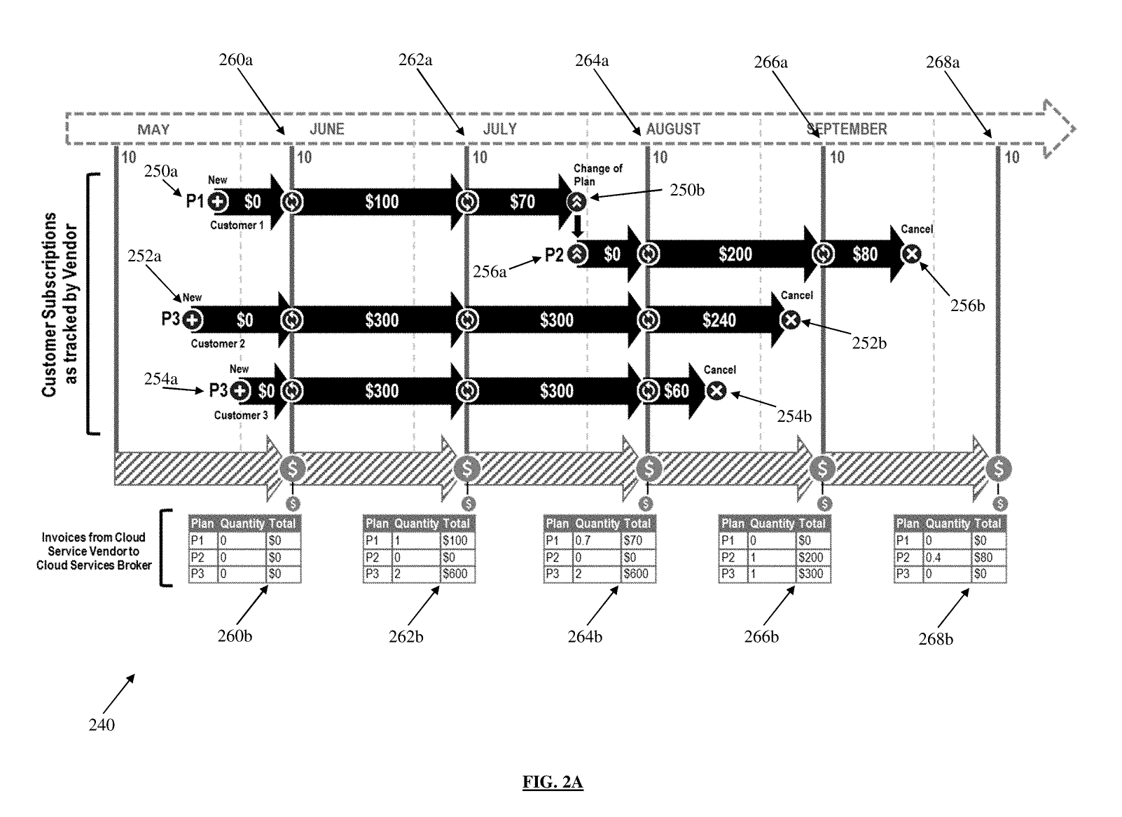

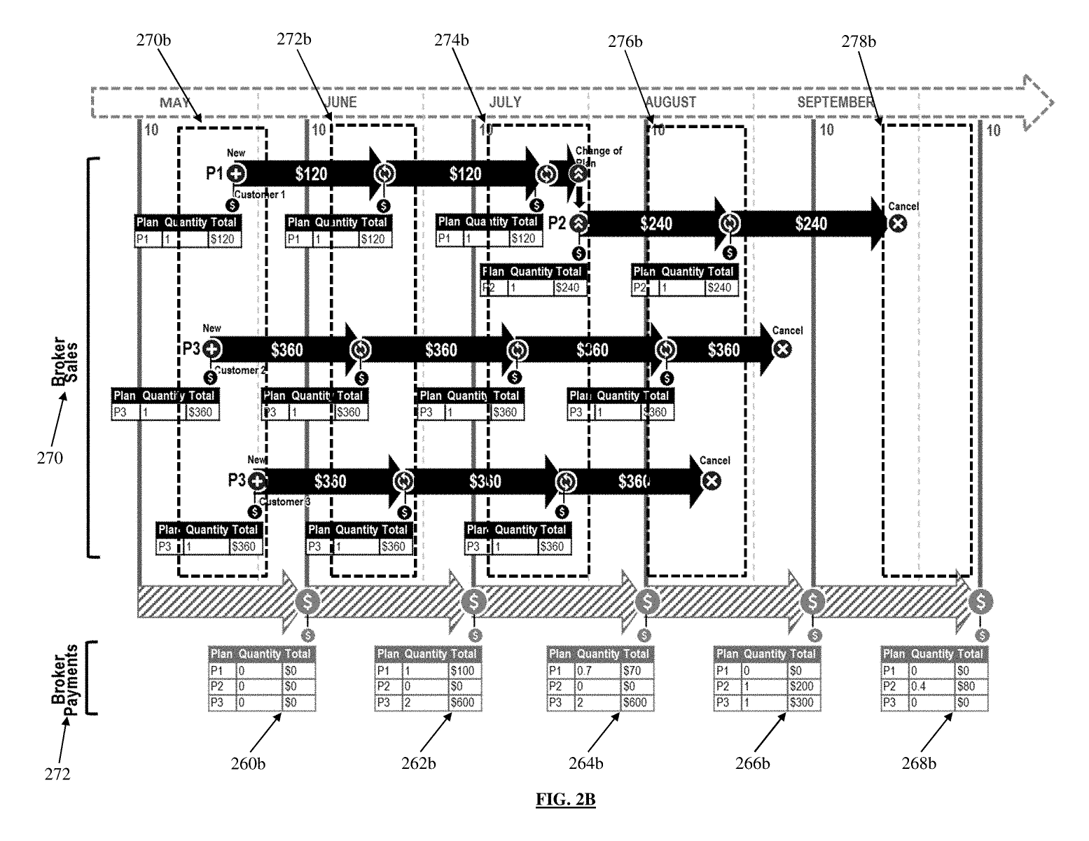

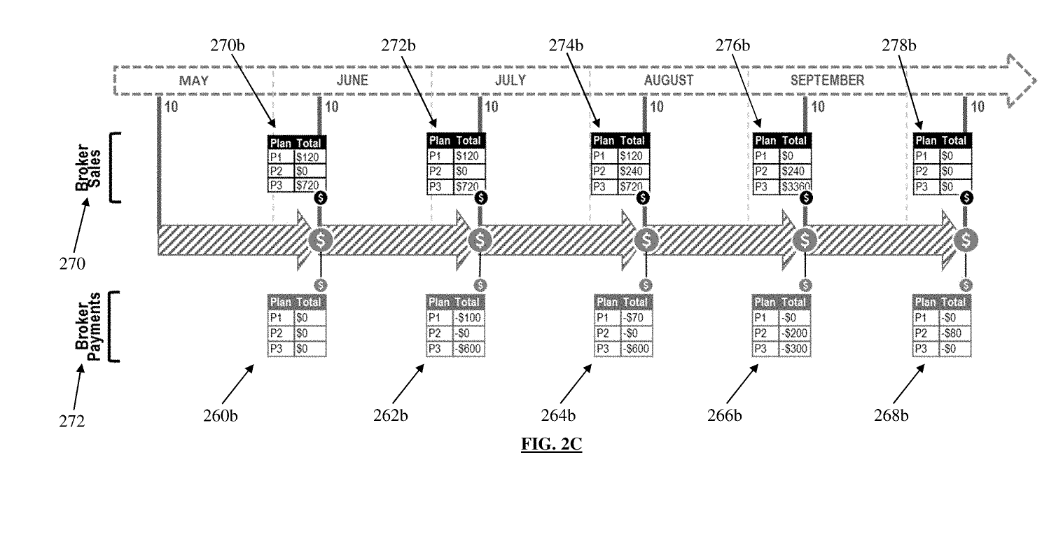

Referring now to FIG. 2, it is shown a flowchart and components of a method for multi-layered billing in a cloud service brokerage, generally indicated at 200. The flowchart 200 includes transactions 202, as applied over billing periods 204. In at least one embodiment of the present disclosure, the transactions 202 include a purchase 210, an add-on 212, an upgrade 214, a downgrade 216, and a cancellation 218. Although only select transactions are shown, it will nonetheless be appreciated that the transactions 202 may include any type of transactions as would be well known and practiced by one having ordinary skill in multi-layered billing in a cloud service brokerage.

In at least one embodiment of the present disclosure, the each of the transactions 202 may include transaction attributes such as the start of service date, the billing period, and any incentives, to name a few, non-limiting examples. For example, purchase 210 includes a monthly billing period (i.e. the billing period is a month); and, the incentive includes a first month of free service. It will be appreciated that the transaction attributes (also known as billing rules), come from contracts between the various entities (e.g. cloud broker 104, first resellers 106, etc.) in the system 100. It will be further appreciated that other billing rules may be included for the each of the transactions 202, such as, for example, free period, payment in full, proration for purchase and/or cancellation, add-on, upgrade, downgrade, alignment (e.g. the alignment of billing periods between a parent subscription and a child subscription), and anniversary date.

In at least one embodiment of the present disclosure, subscribers (e.g. end customers 112) may initiate a transaction, whereby the subscriber's billing cycle is updated or initiated based on the transaction attributes. For example, purchase 210 is a transaction to purchase a service. The purchase 210's attributes include a monthly cadence (i.e. a monthly billing cycle), with a first month of free service as the incentive. Therefore, in the first billing cycle, (i.e. the first month), the subscriber is not charged with any fees. Similarly, the same subscriber may initiate an add-on 212 after a few months. In such an example, the costs of the add-on 212 are added to the total costs of the subscriber's services. As shown in FIG. 2, subscriber cost 210a is supplemented by subscriber cost 212a in the third month. The add-on 212's attributes show that its billing cycle is aligned with that of the parent (i.e. the purchase 210). Therefore, the add-on 212 will be billed during the same billing cycle as purchase 210. As shown in FIG. 2, add-on 212 includes a free first month as an incentive. It will be appreciated that add-on 212 may have its own alignment attribute such that its billing cycle does not align with that of the parent (i.e. the purchase 210).

In at least one embodiment of the present disclosure, a subscriber may also want to upgrade a service. For example, an upgrade 214 transaction may be initiated (for example, at the marketplace 122), whereby the subscriber cost 214a is modified to the upgraded subscriber cost 214b (as shown in FIG. 2). The upgrade 214 includes attributes of proration during the ‘old’ period, and proration during the ‘new’ period. It will be appreciated that during the billing cycle during which the upgrade 214 is initiated, the transition from subscriber cost 214a to subscriber cost 214b is such that the subscriber's costs are prorated for the monthly billing cycle, on either side of the transition (i.e. the subscriber is prorated based on the subscriber cost 214a from the start of the billing cycle, to before the upgrade; and, is prorated based on subscriber cost 214b from the point of upgrade to the end of the billing cycle).

In at least one embodiment of the present disclosure, a billing period costs 220 is calculated at the end of each billing period, based on the summation of the plurality of costs incurred by the subscriber. For example, during the billing period 220a, and assuming that one subscriber has initiated all the transactions 202, the subscriber's costs may include, the subscriber costs 210a, the subscriber costs 212a, the subscriber costs 214a, subscriber costs 216a (including the transition to a downgrade). It will be appreciated that the billing period 220a's costs is a summation of all the individual services costs incurred by the subscriber. It will be further appreciated that such costs may include a cost per reseller, a cost per end customer, or a cost per service vendor, to name a few non-limiting examples.

Referring now to FIG. 2A, it is shown an example 240, of an exemplary method for multi-layered billing in a cloud service brokerage, according to at least one embodiment of the present disclosure. In the example 240, a contract between a service vendor and a cloud broker is defined wherein a plurality of subscriptions to the service vendor are created (i.e. subscription to plan P1, subscription to plan P2, and subscription to plan P3, and wherein the plan P1 costs $100, the plan P2 costs $200, and the plan P3 costs $300, for each billing period). It will be appreciated that the each of the plurality of subscriptions includes a plurality of billing attributes therewith. In example 240, the each of the plurality of subscriptions has a subscription alignment, wherein the anniversary date falls on the tenth (10^{th}) day of each month (which is the start/end of each billing period for the each of the plurality of subscriptions). Furthermore, the each of the plurality of subscriptions includes a promotion period wherein the service vendor offers a free period until the first anniversary date. The each of the plurality of subscriptions also includes provisions to prorate, and invoice after the end of each billing period. It will be appreciated that the billing attributes for each subscription may depend on the service vendor 102.

Continuing with example 240, a first subscriber (e.g. an end customer 112) may initially subscribe to service plan P1, as shown at 250a; a second subscriber may initially subscribe to a service plan P3, as shown at 252a; and a third subscriber may initially subscribe to service plan P3, as shown at 254a. At the end of the billing cycle, for the each of the subscribers, the service vendor 102 would send a billing invoice to the appropriate cloud broker (e.g. cloud broker 104), as shown at 260b, 262b, 264b, 266b, and 268b. For example, 260b indicates the total costs for subscribing to the plans P1, P2, and P3 during the billing period 260a. In the present example, the costs at 260b are $0 because the each of the plans includes a promotional free period of service that concludes at the first anniversary, as defined above. Similarly, at 262b (the costs for billing period 262a), the cost for plan P1 is $100, the cost for plan P2 is $0, and the cost for plan P3 is $600.

Continuing with the above example, it is shown in FIG. 2B, contracts between the cloud broker 104 and its subscriber (e.g. end customers 112a, 112b, 112c, 112d), wherein the subscriber enrolls in monthly subscriptions. As shown in FIG. 2B, plan P1 costs $120, plan P2 costs $240, and plan P3 costs $360, for subscriber(s). It will be further appreciated that the attributes applied to the each of the plans includes: a subscriptions alignment wherein the anniversary day falls on the day of purchase; no free period included; no refund for changes in a plan; prorated cancellations; and a prepayment of fees.

Following the billing model shown in FIG. 2B, the broker sales 270 for each period is according to the total amount of sales for the billing period. For example, during period 270b, the total cost for plan P1 is $120, the total cost for plan P2 is $0, and the total cost for plan P3 is $720. Similarly, for the period 272b, the total cost for plan P1 is $120, the total cost for plan P2 is $0, and the total cost for plan P3 is $720. Continuing with this example, for the period 274b, the total cost for plan P1 is $120, the total cost for plan P2 is $240, and the total cost for plan P3 is $720.

In at least one embodiment of the present disclosure, the system 100 is further configured to maintain records of the contracts and subscriptions for each service vendor (e.g. service vendor 102), resellers (e.g. resellers 106), and end customer (e.g. end customers 112). It will be appreciated that this allows each entity in the hierarchy to perform reconciliation and profit and loss analysis. For example, referring to FIG. 2C, it is shown a settlements and reconciliation between cloud broker 104's broker sales 270, and cloud broker's 104's broker payments 272. In this example, the brokers sales in the period 270b for plan P1 is $120, whereas the broker payments during same billing period for plan P1 is $0, as shown an 260b. As shown in FIG. 2C, it will be appreciated that there is a settlement and reconciliation between broker sales 270 and broker payments 272 for any billing period.

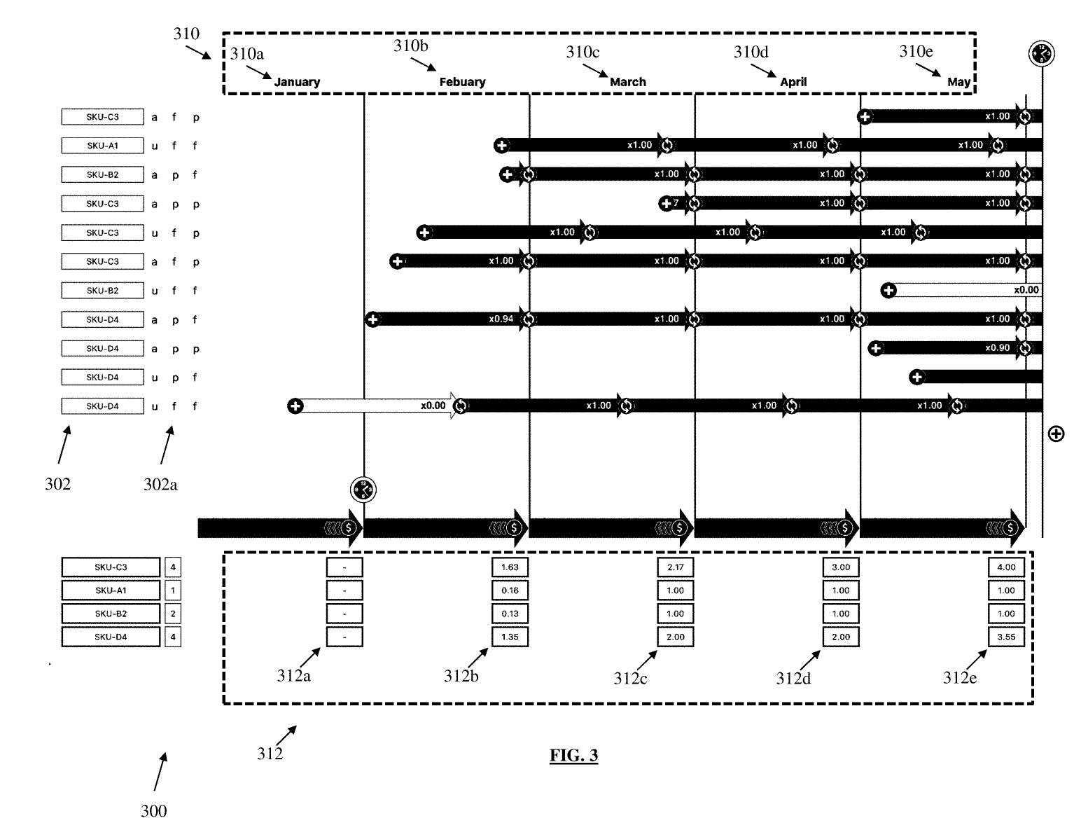

Referring now to FIG. 3, it is shown a flowchart and components of a method for multi-layered billing in a cloud service brokerage, generally indicated at 300. The flowchart 300 shows services 302, service attributes 302a, billing periods 310, and monthly costs 312. In at least one embodiment of the present disclosure, the each of the services 302 represents a service that has been subscribed to by a subscriber (e.g. end customers 112). It will be appreciated that the services 302 may be received from the cloud broker 104 when service vendor 102 contract with the cloud broker 104 to sell service via the cloud broker 104. In at least one embodiment of the present disclosure, the each of the services 302 has associated therewith, service attributes 302a. For example, the service identifier “SKU-C3” includes the attributes “a,” “f,” and “p,” wherein ‘a’ indicates that SKU-C3 is aligned; ‘f’ indicates that it has a free first period; and ‘p’ indicates that it is prorated, for example, during cancellation.

In at least one embodiment of the present disclosure, the each of the monthly costs 312 is calculated by adding the each of the individual costs of the services, during particular billing periods 310. For example, during the billing period 310b (February), the total monthly cost 312b includes the costs associated with SKU-A1, SKU-B2, SKU-C3(afp), SKU-C3 (afp), SKU-D4 (apf), and SKU-D4 (uff). It will be appreciated that the each of the monthly costs 312 are calculated by adding the each individual costs associated with the services 302, based on the each of the service attributes 302a.

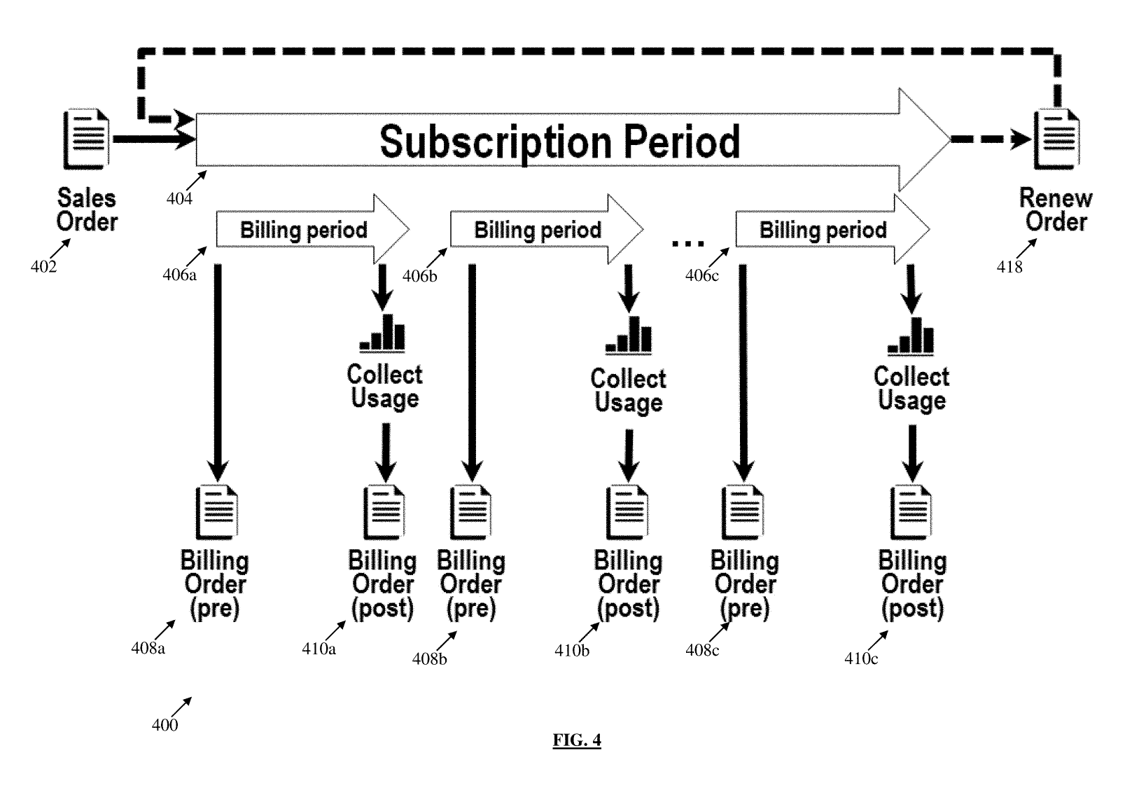

Referring now to FIG. 4, it is shown a flowchart and components of a method for multi-layered billing in a cloud service brokerage, generally indicated at 400. In at least one embodiment of the present disclosure, a sales order 402 is generated. The sale order 402 is indicative of a subscription period 404 wherein the subscription period is divided into a plurality of billing periods (406a, 406b, and 406c). For the each of the billing periods, a billing cost is calculated. For example, in billing period 406a, a billing pre-order 408a is calculated. At the end of the billing period 406a, usage is collected. At the end of the billing period 406a, a billing post-order 410a is calculated. It will be appreciated that the subscription period 404 may be divided into a plurality of billing periods based on the sales order 402, or some other agreed upon contract terms between the subscriber and the service providers (e.g. service vendor 102, or resellers), or even the end customer.

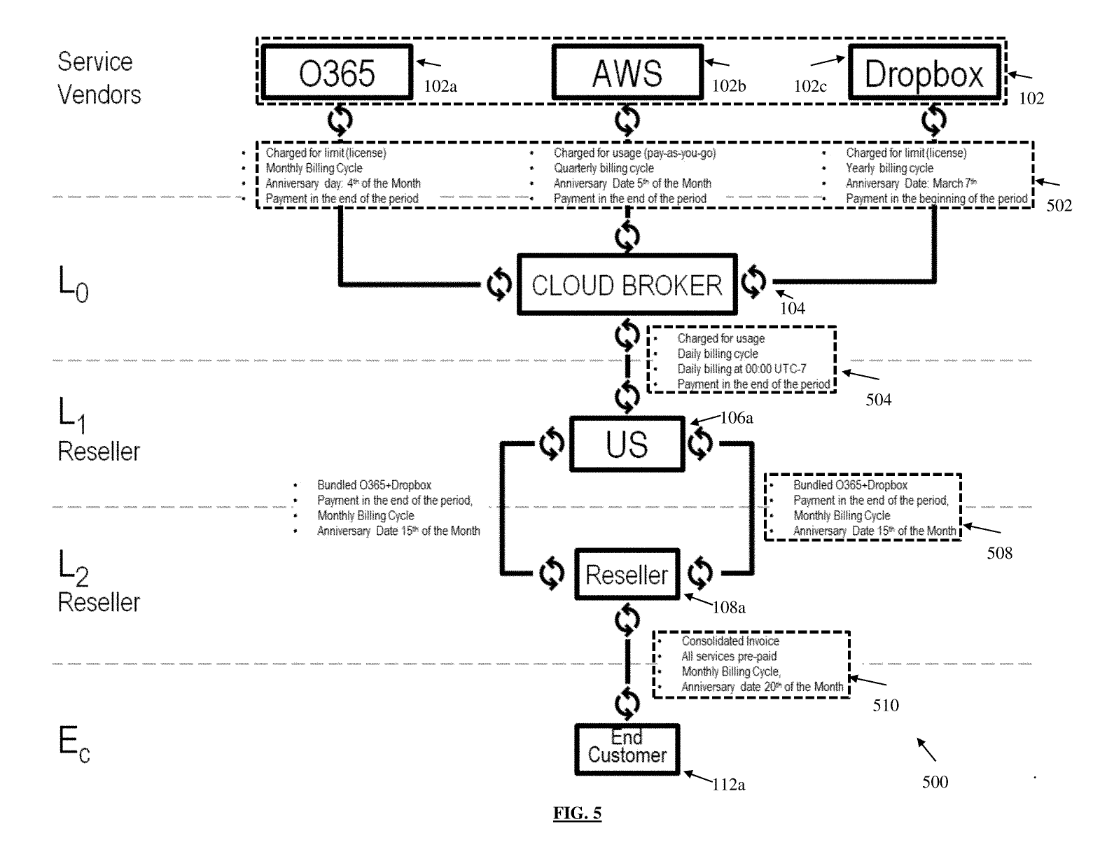

Referring now to FIG. 5, it is shown a method and components for multi-layered billing in a cloud service brokerage, generally indicated at 500. The method 500 includes steps 502 of calculating costs at the each of the service vendor 102; step 504 of calculating service costs at the cloud broker 104; step 508 of calculating costs at the resellers 106a and 108a; and step 510 of generating a consolidated invoice for end customer(s) 112a.

In at least one embodiment of the present disclosure, costs are calculated for the each of the service vendor 102, at step 502. For example, the cloud broker 104 has contract information for each of the service vendor 102 from when the service vendor 102 was first set up (i.e. made ‘available’). For each of the service vendor 102, a contract based pricing scheme is developed. For example, service vendor 102a may charge on a monthly billing cycle based on a license structure, with a billing anniversary falling on the 4^{th} day of the month, with payment in the end of the period. Similarly, service vendor 102b, as an example, may change on a quarterly billing cycle based on a ‘pay-as-you-go’ scheme, with an anniversary date falling on the 5^{th} of the month, with payment at the end of the billing period.

In at least one embodiment of the present disclosure, costs are calculated at the cloud broker 104, at step 504. For example, the cloud broker 104 may have to generate billing invoices on a monthly billing period basis, even though service vendor 102b bills on a quarterly basis. In such an exemplary embodiment, the cloud broker 104 is configured to calculate costs based on expected costs if the billing period of the service vendor is in the future.

In at least one embodiment of the present disclosure, costs are calculated for the resellers 106a and 108a, at step 508. Here again, the each of the resellers 106a and 108a may have independent contract terms such that the billing characteristics are different from that of the service vendor 102. For example, at reseller 108a, service vendor 102a (office365®) may have an anniversary date falling on the 15^{th} of the month, but as noted, service vendor 102a bills on the 4^{th} of the month.

In at least one embodiment of the present disclosure, a consolidated invoice is generated for end customer(s) 112a, at step 510. It will be appreciated that for the end customer 112a, a single invoice is generated such that all costs arising from end customer 112a's subscription are generated onto a single invoice based on the end customer 112a's billing characteristics. It will be appreciated that the end customer 112a's billing characteristics may be different from that of the upstream entities (e.g. service vendor 102, and resellers 106a and 108a).

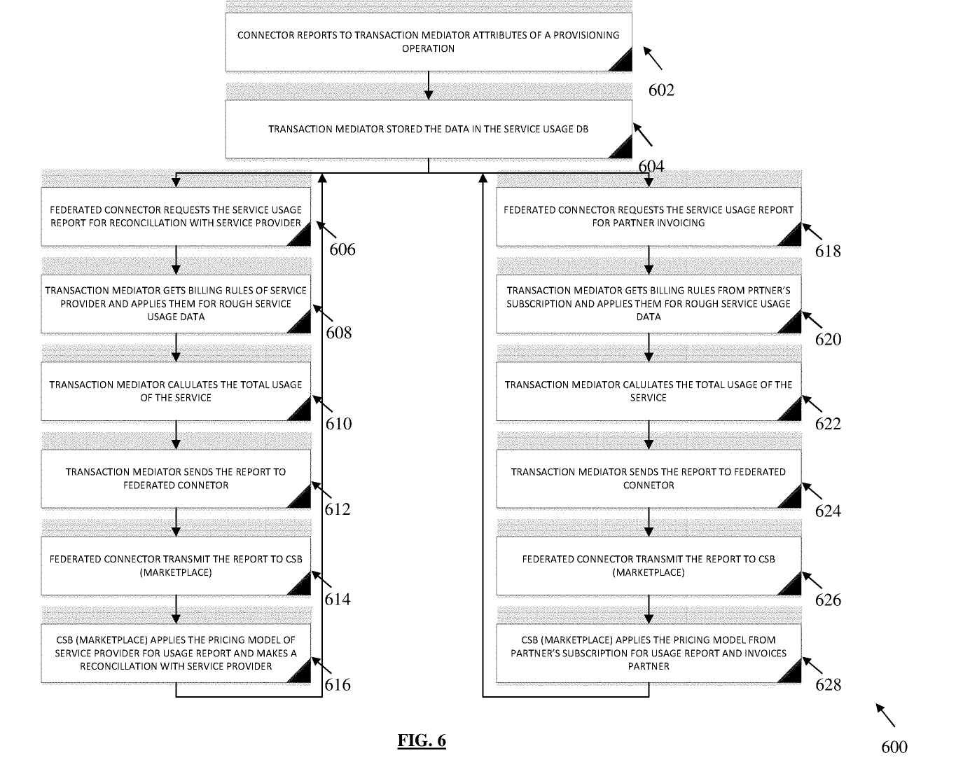

Referring now to FIG. 6, it is shown a method for multi-layered billing in a cloud service brokerage, generally indicated at 600. In at least one embodiment of the present disclosure, the method includes step 602 of the connector 138 reporting attributes of a provisioning operation to the transaction mediator 132; step 604 of the transaction mediator 132 storing the data in the service usage database 134; step 606 of the federated connector 130 requesting the service usage report for reconciliation with the service vendor 102; step 608 of the transaction mediator 132 receiving billing rules of service vendor 102 to determine service usage; step 610 of the transaction mediator 132 calculating the total usage of the service; step 612 of the transaction mediator 132 sending the report to the federated connector 130; step 614 of the federated connector 130 transmitting the report to the marketplace broker 128; step 616 of the marketplace broker 128 applying the pricing model of the service vendor 102 to create a usage report for reconciliation with the service vendor 102; step 618 of the federated connector 130 requesting the service usage report for partner 104a invoicing; step 620 of the transaction mediator 132 receiving billing rules from the partner 104a's subscription, and the transaction mediator 132 applying the billing rules to determine the service usage data; step 622 of the transaction mediator 132 calculating the total usage of the service; step 624 of the transaction mediator 132 sending the report to the federated connector 130; step 626 of the federated connector 132 transmitting the report to the marketplace broker 128; and step 628 of the marketplace broker 128 applying the pricing model from the partner 104a's subscription for usage report and invoicing the partner 104a.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A system for multi-layered billing in a cloud service brokerage comprising:
at least one service vendor configured to provide software services, and operably connected to a cloud service broker;
the cloud service broker comprising:
a connector configured to integrate the at least one service vendor's software services, the connector further configured to establish a communication provisioning channel configured to provision integrated software services; and
at least one transaction mediator configured to monitor services transactions of the integrated software services, via the connector;
at least one downstream subscriber operably connected to the cloud service broker, and subscribing to the integrated software services;
the cloud service broker configured to receive, service vendor pricing rules and service vendor billing rules for the each of the at least one service vendors;
the cloud service broker further configured to receive downstream subscriber pricing rules and downstream subscriber billing rules for the each of the at least one downstream subscriber;
the cloud service broker further configured to apply the service vendor pricing rules and the service vendor billing rules based at least in part on the usage of the integrated software services by the each of the at least one downstream subscribers;
the cloud service broker further configured to calculate settlements and perform reconciliations, the settlements and reconciliations based at least in part on the service vendor pricing rules, the service vendor billing rules, the subscriber pricing rules, and the subscriber billing rules; and
the cloud service broker further configured to calculate a profit-loss, wherein, the profit-loss is determined by the difference in fees paid to the at least one service vendor, and fees received from the at least one downstream subscriber.

2. The system of claim 1, wherein, the at least one downstream subscriber is selected from a group consisting of a reseller, a subreseller, a tenant, and an end customer.

3. The system of claim 1, wherein, the at least one downstream subscriber is configured to further provision the integrated software services to at least one secondary downstream subscriber.

4. The system of claim 3, wherein, the at least one secondary downstream subscriber is selected from a group consisting of a reseller, a subreseller, a tenant, and an end customer.

5. The system of claim 1, wherein, the cloud service broker is further configured to generate a settlements and reconciliations report.

6. The system of claim 1, wherein, the services transactions are selected from a group consisting of a subscription activation date, a subscription cancellation date, an integrated software services change, an integrated software services identifier, a downstream subscriber identifier, the software services, and a service marker.

7. The system of claim 5, wherein, the service marker is selected from a group consisting of an activation action, a change action, and a cancellation action.

8. The system of claim 1, wherein, the service vendor pricing rules and the service vendor billing rules comprise subscription contracts between the at least one service vendor and the cloud service broker.

9. The system of claim 1, wherein, the downstream subscriber pricing rules and the downstream subscriber billing rules comprise contracts between the cloud service broker and the at least one downstream subscriber.

10. The system of claim 3, wherein, the downstream subscriber pricing rules and the downstream subscriber billing rules further comprise contracts between the at least one downstream subscriber and the at least one secondary downstream subscriber.

11. The system of claim 1, wherein the cloud service broker is operably connected to a partner broker.

12. The system of claim 11, wherein the cloud service broker is further configured to provision the integrated software services to the partner broker based at least in part on a license obtained by the partner broker, to the integrated software services.

13. The system of claim 12, further comprising a federated connector operably connected to the transaction mediator, and configured to monitor usage of the integrated software services by the partner broker.

14. The system of claim 12, wherein the transaction mediator is configured to receive the services transactions and apply service vendor pricing rules and service vendor billing rules to the services transactions.

15. A computer implemented method for multi-layered billing in a cloud service brokerage, the method comprising:
configuring a software service at least one service vendor, the at least one service vendor operably connected to a cloud service broker;
integrating at the cloud service broker, the at least one service vendor's software services, to create integrated software services;
establishing at the cloud service broker, a communication provisioning channel configured to provision integrated software services;
monitoring using at least one transaction mediator and via the connector, services transactions of the integrated software services;
creating at the cloud service broker, a subscription to the integrated software services, the subscription operably accessible to at least one downstream subscriber;
receiving at the cloud service broker, service vendor pricing rules and service vendor billing rules, for the each of the at least one service vendors;
receiving at the cloud service broker, downstream subscriber pricing rules and downstream subscriber billing rules, for the each of the at least one downstream subscribers;
applying at the cloud service broker, the service vendor pricing rules and the service vendor billing rules based at least in part on the usage of the integrated software services by the each of the at least one downstream subscribers;
calculating and performing at the cloud service broker, settlements and reconciliations, the settlements and reconciliations based at least in part on the service vendor pricing rules, the service vendor billing rules, the subscriber pricing rules, and the subscriber billing rules; and
calculating at the cloud service broker, a profit-loss determined by the difference in fees paid to the at least one service vendor, and fees received from the at least one downstream subscriber.

16. The method of claim 15, wherein the at least one downstream subscriber is selected from a group consisting of a reseller, a subreseller, a tenant, and an end customer.

17. The method of claim 15, further comprising the step of provisioning, by the at least one downstream subscriber, the integrated software services to at least one secondary downstream subscriber.

18. The method of claim 17, wherein the at least one secondary downstream subscriber is selected from a group consisting of a reseller, a subreseller, a tenant, and an end customer.

19. The method of claim 15, further comprising the step of generating, at the cloud service broker, a settlements and reconciliations report.

20. The method of claim 15, wherein, the services transactions are selected from a group consisting of a subscription activation date, a subscription cancellation date, an integrated software services change, an integrated software services identifier, a downstream subscriber identifier, the software services, and a service marker.

21. The method of claim 15, wherein the service marker is selected from a group consisting of an as activation action, a change action, and a cancellation action.

22. The method of claim 15, wherein, the service vendor pricing rules and the service vendor billing rules comprise subscription contracts between the at least one service vendor and the cloud service broker.

23. The method of claim 15, wherein, the downstream subscriber pricing rules and the downstream subscriber billing rules comprise contracts between the cloud service broker and the at least one downstream subscriber.

24. The method of claim 17, wherein the downstream subscriber pricing rules and the downstream subscriber billing rules comprise contracts between the at least one downstream subscriber and the at least one secondary subscriber.

25. The method of claim 15, further comprising the step of operably connecting the cloud service broker to a partner broker.

26. The method of claim 25, further comprising the step of provisioning the integrated software services to the partner broker based at least in part on a license obtained by the partner broker, to the integrated software services.

27. The method of claim 26, further comprising the step of monitoring, at a federated connector, usage of the integrated software services by the partner broker, the federated connector operably connected to the transaction mediator.

28. The method of claim 15, further comprising the step of receiving at the transaction mediator, the services transactions, and applying service vendor pricing rules and service vendor billing rules to the services transactions.
